(19) United States
(12) Patent Application Publication
(10) Pub. No.: US 2023/0335124 A1
(43) Pub. Date: Oct. 19, 2023

(54) Comparison Scoring For Hypothesis Ranking

(71) Applicant: Google LLC, Mountain View, CA (US)

(72) Inventors: Leonid Aleksandrovich Velikovich, New York, NY (US); Petar Stanisa Aleksic, Jersey City, NJ (US)

(73) Assignee: Google LLC, Mountain View, CA (US)

(21) Appl. No.: 17/659,327

(22) Filed: Apr. 14, 2022

(51) Int. Cl. G10L 15/197; G10L 15/22; G10L 15/28

(52) U.S. Cl. CPC G10L 15/197; G10L 15/22; G10L 15/28; G10L 2015/228

(57) ABSTRACT

A method includes receiving, from a speech recognizer, multiple existing candidate hypotheses for an utterance. Each existing candidate hypothesis has a corresponding likelihood score assigned by the speech recognizer. The method also includes generating, using a correction module configured to receive the multiple candidate hypotheses as input, a new candidate hypothesis and determining, using a comparison model configured to receive the corresponding likelihood score assigned to one of the multiple existing candidate hypotheses as input, a corresponding likelihood score. The method also includes ranking the multiple existing candidate hypotheses and the new candidate hypothesis based on the corresponding likelihood scores assigned to the multiple existing candidate hypothesis by the speech recognizer and the corresponding likelihood score for the new candidate hypothesis. The method also includes generating a transcription of the utterance by selecting the highest ranking one of the new candidate hypothesis and the multiple existing candidate hypotheses.

### TECHNICAL FIELD

This disclosure relates to comparison scoring for hypothesis ranking.

### BACKGROUND

Modern automatic speech recognition (ASR) systems focus on providing not only quality/accuracy (e.g., low word error rates (WERs)), but also low latency (e.g., a short delay between the user speaking and a transcription appearing). Due to sparsity in generalized training data used to train ASR systems in performing speech recognition tasks, ASR systems have difficulty recognizing specialized phrases that include medical/legal terminology, and proper nouns such as personal contacts, song/artist names, applications, and emergence of new entity names. By the same notion, ASR systems have difficulty recognizing terms in cross-lingual utterances that are in a language different than a language of the training data. As a result, speech recognition lattices either rank these specialized phrases low or omit the specialized phrases entirely.

### SUMMARY

One aspect of the disclosure provides a computer-implemented method that when executed on data processing hardware causes the data processing hardware to perform operations that include receiving, from a speech recognizer, multiple existing candidate hypotheses for an utterance spoken by a user and generating, using a correction module configured to receive the multiple candidate hypotheses as input, a new candidate hypothesis that corresponds to another candidate transcription for the utterance. Each existing candidate hypothesis of the multiple existing candidate hypotheses corresponds to a candidate transcription for the utterance and has a corresponding likelihood score assigned by the speech recognizer to the corresponding existing candidate hypothesis. After generating the new candidate hypothesis, the operations also include determining, using a comparison model configured to receive the corresponding likelihood score assigned to one of the multiple existing candidate hypotheses as input, a corresponding likelihood score for the new candidate hypothesis, and ranking the multiple existing candidate hypotheses and the new candidate hypothesis based on the corresponding likelihood scores assigned to the multiple existing candidate hypothesis by the speech recognizer and the corresponding likelihood score determined for the new candidate hypothesis using the comparison model. Thereafter, the operations also include generating a transcription of the utterance spoken by the user by selecting the highest ranking one of the new candidate hypothesis and the multiple existing candidate hypotheses.

Implementations of the disclosure may include one or more of the following optional features. In some implementations, the operations also include receiving audio data corresponding to an utterance spoken by a user and processing, using the speech recognizer, the audio data to generate a lattice of candidate hypotheses having corresponding likelihood scores assigned by the speech recognizer. Here, receiving the multiple existing candidate hypotheses includes selecting an n-best list of the candidate hypotheses that have the highest corresponding likelihood scores assigned by the speech recognizer. In these implementations, the new candidate hypothesis generated using the correction module may include one of the candidate hypotheses in the lattice of candidate hypotheses that has a corresponding likelihood score that is less than each of the corresponding likelihood scores assigned to the n-best list of candidate hypotheses from the lattice. Alternatively, the new candidate hypotheses generated using correction module may be absent from the lattice of candidate hypotheses.

In some examples, the operations also include receiving context information indicating a current context when the user spoke the utterance, and when generating the new candidate hypothesis, the correction module is further configured to receive the context information as input. Additionally or alternatively, the operations may also include receiving context information indicating a current context when the user spoke the utterance, and when determining corresponding likelihood score for the new candidate hypothesis, the comparison model is further configured to receive the context information as input. The context information may include at least one of: a list of personal contacts of the user; names of items in in a media library associated with the user; names of nearby locations; an application currently executing on a user device associated with the user; or names of applications installed on the user device. In some implementations, the context information indicates at least one of music is playing on a user device associated with the user; content is streaming from the user device onto a screen or media device in communication with the user device; an application executing on the user device in the foreground; a dialog state of the foreground application; any on-screen information; a current activity being performed by the user; user history data; or any user-specific and/or non-user-specific freshness trends.

The speech recognizer may include an end-to-end speech recognition model configured to generate the corresponding likelihood score for each of the multiple existing candidate hypotheses. Additionally or alternatively, the correction module may include an auxiliary language model external to the speech recognizer.

Another aspect of the disclosure provides a system that includes data processing hardware and memory hardware in communication with the data processing hardware. The memory hardware stores instructions that when executed on the data processing hardware causes the data processing hardware to perform operations including receiving, from a speech recognizer, multiple existing candidate hypotheses for an utterance spoken by a user and generating, using a correction module configured to receive the multiple candidate hypotheses as input, a new candidate hypothesis that corresponds to another candidate transcription for the utterance. Each existing candidate hypothesis of the multiple existing candidate hypotheses corresponds to a candidate transcription for the utterance and has a corresponding likelihood score assigned by the speech recognizer to the corresponding existing candidate hypothesis. After generating the new candidate hypothesis, the operations also include determining, using a comparison model configured to receive the corresponding likelihood score assigned to one of the multiple existing candidate hypotheses as input, a corresponding likelihood score for the new candidate hypothesis, and ranking the multiple existing candidate hypotheses and the new candidate hypothesis based on the corresponding likelihood scores assigned to the multiple existing candidate hypothesis by the speech recognizer and the corresponding likelihood score determined for the new candidate hypothesis using the comparison model. Thereafter, the operations also include generating a transcription of the utterance spoken by the user by selecting the highest ranking one of the new candidate hypothesis and the multiple existing candidate hypotheses

This aspect may include one or more of the following optional features implementations of the disclosure may include one or more of the following optional features. In some implementations, the operations also include receiving audio data corresponding to an utterance spoken by a user and processing, using the speech recognizer, the audio data to generate a lattice of candidate hypotheses having corresponding likelihood scores assigned by the speech recognizer. Here, receiving the multiple existing candidate hypotheses includes selecting an n-best list of the candidate hypotheses that have the highest corresponding likelihood scores assigned by the speech recognizer. In these implementations, the new candidate hypothesis generated using the correction module may include one of the candidate hypotheses in the lattice of candidate hypotheses that has a corresponding likelihood score that is less than each of the corresponding likelihood scores assigned to the n-best list of candidate hypotheses from the lattice. Alternatively, the new candidate hypotheses generated using correction module may be absent from the lattice of candidate hypotheses.

In some examples, the operations also include receiving context information indicating a current context when the user spoke the utterance, and when generating the new candidate hypothesis, the correction module is further configured to receive the context information as input. Additionally or alternatively, the operations may also include receiving context information indicating a current context when the user spoke the utterance, and when determining corresponding likelihood score for the new candidate hypothesis, the comparison model is further configured to receive the context information as input. The context information may include at least one of: a list of personal contacts of the user, names of items in in a media library associated with the user; names of nearby locations, an application currently executing on a user device associated with the user; or names of applications installed on the user device. In some implementations, the context information indicates at least one of: music is playing on a user device associated with the user; content is streaming from the user device onto a screen or media device in communication with the user device; an application executing on the user device in the foreground; a dialog state of the foreground application; any on-screen information; a current activity being performed by the user; user history data; or any user-specific and/or non-user-specific freshness trends.

The speech recognizer may include an end-to-end speech recognition model configured to generate the corresponding likelihood score for each of the multiple existing candidate hypotheses. Additionally or alternatively, the correction module may include an auxiliary language model external to the speech recognizer

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is an example system for scoring a new candidate hypothesis inserted into an existing lattice of candidate hypotheses for an utterance.

FIGS. 2A and 2B are schematic views of diagrams that illustrate examples of word lattices.

FIG. 3 is a schematic view depicting a training process for training a comparison model used by the system of FIG. 1.

FIG. 4 is a flowchart of an example arrangement of operations for a method of scoring a new candidate hypothesis inserted into an existing lattice of candidate hypotheses for an utterance.

FIG. 5 is a schematic view of an example computing device that may be used to implement the systems and methods described herein.

Like reference symbols in the various drawings indicate like elements.

### DETAILED DESCRIPTION

Automatic speech recognition (ASR) systems are becoming increasingly popular in client devices as the ASR systems continue to provide more accurate transcriptions of what users speak. Recently, end-to-end (E2E) ASR models have gained popularity in achieving state-of-the-art performance in accuracy and latency. In contrast to conventional hybrid ASR systems that include separate acoustic, pronunciation, and language models, E2E ASR models apply a sequence-to-sequence approach to jointly learn acoustic and language modeling in a single neural network that is trained end to end from training data, e.g., utterance-transcription pairs. Still, in some instances, ASR models generate inaccurate transcriptions that misrecognize what the user actually spoke. This is often the case when user speaks a unique phrase that is sparse in or non-existent in training data used to train the ASR model. As a result, a correct hypothesis for the unique phrase either has a low rank in a recognition lattice of possible speech recognition hypotheses or is missing entirely.

Existing techniques for improving recognition of a unique phrase is to typically boost relevant speech recognition hypotheses that contain the unique phrase or insert a new hypothesis including the unique phrase into the lattice of possible speech recognition hypotheses. An often overlooked consideration is how to accurately rank new or modified hypotheses relative to existing hypotheses output by the ASR model. A new hypothesis for insertion into the lattice of existing speech recognition hypotheses may be derived from a correction module after the ASR model either failed to generate the hypothesis or assigned the hypothesis a low probability score. Without accurate ranking of hypotheses in a speech recognition lattices, ASR systems risk either over-triggering a contextual hypothesis that was not spoken or under-recalling the contextual hypothesis even when spoken. For instance, consider a spoken utterance of “call Petar” that an ASR models produces a speech recognition hypothesis of “call Peter”. Accurate ranking of inserting a new hypothesis of “call Petar” must consider whether Peter and Petar are personal contacts, whether either Peter or Petar is a generic entity likely to be spoken in utterances, an acoustic fit to audio observations, and if other better speech recognition hypotheses are present in the lattice.

In order to accurately rank the new hypothesis alongside existing speech recognition hypotheses in the lattice, the new hypothesis needs to be accurately scored. The ASR model that generated the existing speech recognition hypotheses in the lattice is not a good fit for scoring a new hypothesis since it already failed to recall, or assigned it a low score, during decoding. On the other hand, context-specific models such as biasing models that bias speech recognition results toward terms relevant to a given context do not have the ability to rank a speech recognition hypothesis that is in-domain relative to out-of-domain traffic that includes terms which the ASR model is trained on.

The use of E2E ASR models further complicates the ability to score new hypotheses relative to existing hypotheses since it is difficult for these models to correlate the probability scores originally assigned to the existing speech recognition hypotheses. Namely, the output of a single score by E2E ASR models obscures distinctions between two different types of misrecognized hypotheses. The first type of misrecognized hypothesis closely matches an acoustic ground truth (e.g., high acoustic score) but is linguistically-weak (e.g., low prior likelihood of being uttered). An example misrecognized hypothesis of the first type would include “plain lame is Rob” when the ground-truth utterance is in fact “play Les Miserables” Misrecognition hypotheses of the first type can generally be corrected by locating an acoustically similar, but more probable hypothesis. The second type of misrecognized hypothesis is located in a head of a distribution/lattice (e.g., high prior likelihood) of possible speech recognition hypotheses but poorly matches the acoustic ground truth (e.g., low acoustic score). An example misrecognized hypothesis of the second type would include “Call of Duty” when the ground-truth utterance is in fact “call Rudy” where Rudy is a personal contact. As misrecognition hypotheses of the second type have a higher deviation from a phonetic/acoustic ground truth, they cannot be corrected by locating acoustically similar hypotheses as with correcting misrecognition hypotheses of the first type.

Implementations herein are directed toward systems and methods of ranking and scoring existing candidate hypotheses generated by an ASR model for a spoken utterance together with one or more new candidate hypotheses for the spoken utterance output by a correction module after the ASR model generates the existing candidate hypotheses. In particular, a computing system receives audio data for an utterance spoken by a user and the computing system processes the audio data to generate candidate hypotheses representing possible transcriptions for the utterance in a word lattice. Subsequently, the computing system generates a new candidate hypothesis for the utterance using the correction module. Implementations are specifically directed toward training a comparison model to have partial awareness of both in-domain (e.g., context-specific) and out-of-domain (e.g., general purpose) data for use in scoring a new candidate hypothesis inserted into a word (or sub-word) lattice of existing candidate hypotheses output from an ASR model. The trained comparison module uses likelihood scores generated by the ASR model for each of the existing candidate hypotheses of the word lattice as a point of reference for scoring a likelihood score for the new candidate hypothesis inserted into the existing word lattice. While examples herein may refer to the correction module only generating a single new candidate hypotheses for the sake of simplicity, the present disclosure is not so limited and the correction module may generate multiple new candidate hypotheses that may be scored and ranked alongside the existing candidate hypotheses using the trained comparison module. As used herein, a likelihood score indicates a probability that a corresponding candidate hypothesis is a correct transcription of an utterance spoken by a user. Ultimately, the computing system generates/selects a transcription of the utterance by selecting the highest likelihood score of either one of the new candidate hypothesis or one of the existing candidate hypotheses.

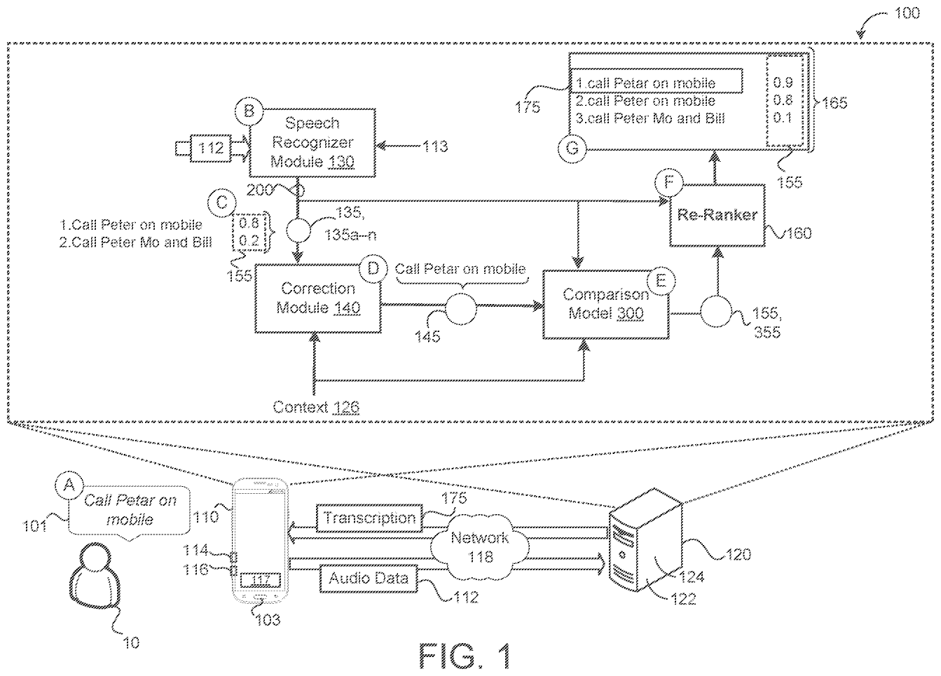

FIG. 1 illustrates an example of a system 100 for automatic speech recognition (ASR) of an utterance 101 spoken by a user 10 using audio data 112 corresponding to the utterance (i.e., query) 101. The system 100 includes a client device 110, a computing system 120, and a network 118. The computing system 120 may be a distributed system (e.g., cloud computing environment) having scalable elastic resources. The resources include computing resources 122 (e.g., data processing hardware) and/or storage resources 124 (e.g., memory hardware). The network 118 can be wired, wireless, or a combination thereof, and may include private networks and/or public networks, such as the internet.

In some examples, the computing system 120 receives audio data 112 from the client device 110, and the computing system 120 processes the audio data 112 to generate multiple candidate hypotheses 135 for the utterance 101 based on the audio data 112. In some additional examples, the client device 110 processes the audio data 112 entirely on-device to generate the multiple candidate hypotheses for the utterance 101 based on the audio data 112. Here, each candidate hypothesis corresponds to a candidate transcription for the utterance 101 and is represented by a respective sequence of hypothesized terms.

As described in greater detail below, after generating the multiple candidate hypotheses 135, a correction module 140 (executing on the client device 110 or the computing system 120) generates one or more new candidate hypotheses 145 for the utterance 101 that were either not included in the existing candidate hypotheses 135 or ranked very low among the existing candidate hypotheses in the lattice 200. Thereafter, a comparison model 300, trained specifically to have partial awareness of both in-domain (e.g., context-specific) and out-of-domain (e.g., general purpose) data, scores the new candidate hypothesis 145 together with the existing candidate hypotheses 135 such that the computing system 120 (or the user device 110) generates a transcription 175 for the utterance 101 by selecting a highest ranking hypothesis from the multiple existing candidate hypotheses 135 or the one or more additional candidate hypotheses 145 scored by the comparison model 300.

FIG. 1 shows operations (A) to (G) which illustrate a flow of data. As described herein, the computing system 120 performs operations (B) to (G). However, it is understood that the client device 110 may also perform operations (B) to (G) in addition to, or in lieu of, the computing system 120 performing the operations. In some examples, the client device 110 performs a first portion of the operations (e.g., operations (B) to (D)) and the computing system 120 performs a second portion of the operations (e.g., operations (E) to (G)), or vice-versa.

The client device 110 includes data processing hardware 114 and memory hardware 116. The client device 110 may include one or more audio capture devices (e.g., microphone(s)) 103 for capturing and converting utterances 101 from the user 10 into the audio data 112 (e.g., electrical signals). In some examples, the microphone 103 is separate from the client device 110 and in communication with the client device 110 to provide the recorded utterance 101 to the client device 110. The client device 110 can be any computing device capable of communicating with the computing system 120 through the network 118. In lieu of spoken utterances 101, the user 10 may input textual utterances 101 via a keyboard 117, such as a virtual keyboard displayed in a graphical user interface of the client device 110 or a physical keyboard in communication with the client device 110. The client device 110 includes, but is not limited to, desktop computing devices and mobile computing devices, such as laptops, tablets, smart phones, smart speakers/displays, smart appliances, internet-of-things (IoT) devices, and wearable computing devices (e.g., headphones, headsets and/or watches).

In the example of FIG. 1, during stage (A), the user 10 speaks an utterance 101, and the microphone 103 of the client device 110 records the utterance 101. In this example, the utterance 101 includes the user 10 speaking “call Petar on mobile.” The client device 110 transmits the audio data 112, corresponding to the utterance 101 recorded by the microphone 103, to the computing system 120 via the network 118. During stage (B), the computing system 120 processes the audio data 112 to generate multiple candidate hypotheses 135, 135a-n. Here, each candidate hypothesis 135 corresponds to a candidate transcription for the utterance 101 and is represented by a respective sequence of hypothesized terms. For example, the computing system 120 may execute the speech recognizer module 130 (e.g., an automated speech recognition (ASR) module) for producing a word lattice 200 indicating the multiple candidate hypotheses transcriptions 135 that may be possible for the utterance 101 based on the audio data 112. The speech recognizer module 130 may evaluate potential paths through the word lattice 200 to determine the multiple candidate hypotheses 135

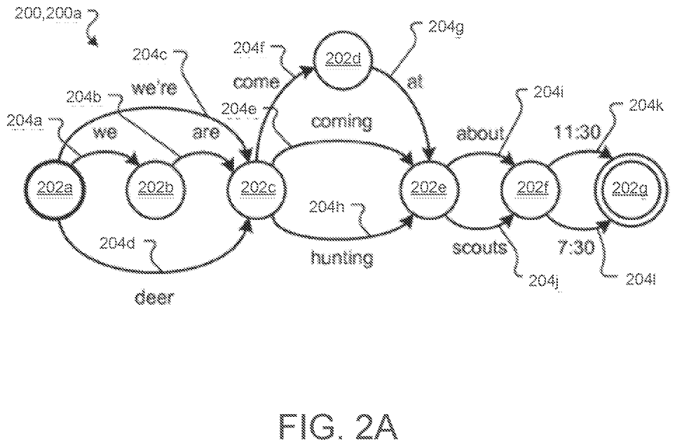

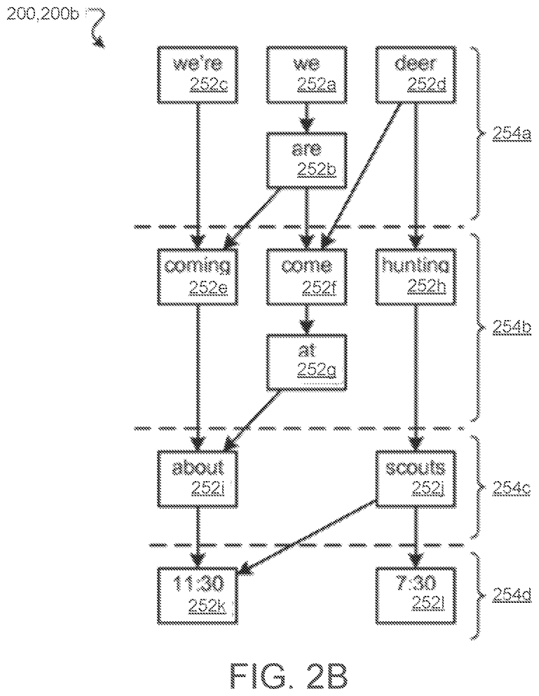

FIG. 2A is illustrates an example of a word lattice 200, 200a that may be provided by the speech recognizer module 130 of FIG. 1. The word lattice 200a represents multiple possible combinations of words that may form different candidate hypotheses 135 for an utterance 101.

The word lattice 200a includes one or more nodes 202a-g that correspond to the possible boundaries between words. The word lattice 200a includes multiple edges 204a-l for the possible words in the candidate hypotheses that result from the word lattice 200a. In addition, each of the edges 204a-l can have one or more weights or probabilities of that edge being the correct edge from the corresponding node. The weights are determined by the speech recognizer module 130 and can be based on, for example, a confidence in the match between the speech data and the word for that edge and how well the word fits grammatically and/or lexically with other words in the word lattice 200a.

For example, initially, the most probable path (e.g., most probable candidate hypothesis 135) through the word lattice 200a may include the edges 204c, 204e, 204i, 204k, which have the text “we're coming about 11:30.” A second best path (e.g., second best candidate hypothesis 135) through the word lattice 200a may include the edges 204d, 204h, 204j, 204l, which have the text “deer hunting scouts 7:30.”

Each pair of nodes may have one or more paths corresponding to the alternate words in the various candidate hypotheses 135. For example, the initial most probable path between the node pair beginning at node 202a and ending at the node 202c is the edge 204c “we're.” This path has alternate paths that include the edges 204a, 204b “we are” and the edge 204d “deer.”

FIG. 2B is an example of a hierarchical word lattice 200, 200b that may be provided by the speech recognizer module 130 of FIG. 1. The word lattice 200b includes nodes 252a-l that represent words that make up the various candidate hypotheses 135 for an utterance 101. The edges between the nodes 252a-l show that the possible candidate hypotheses 135 include: (1) the nodes 252c, 252e, 252i, 252k “we're coming about 11:30”, (2) the nodes 252a, 252b, 252e, 252i, 252k “we are coming about 11:30”; (3) the nodes 252a, 252b, 252f, 252g, 252i, 252k “we are come at about 11:30”; (4) the nodes 252d, 252f, 252g, 252i, 252k “deer come at about 11:30”; (5) the nodes 252d, 252h, 252j, 252k “deer hunting scouts 11:30”; and (6) the nodes 252d, 252h, 252j, 2521 “deer hunting scouts 7:30.”

Again, the edges between the nodes 242a-l may have associated weights or probabilities based on the confidence in the speech recognition (e.g., candidate hypothesis) and the grammatical/lexical analysis of the resulting text. In this example, “we're coming about 11:30” may currently be the best hypothesis and “deer hunting scouts 7:30” may be the next best hypothesis. One or more divisions, 354a-d, can be made in the word lattice 200b that group a word and its alternates together. For example, the division 254a includes the word “we're” and the alternates “we are” and “deer.” The division 252b includes the word “coming” and the alternates “come at” and “hunting.” The division 254c includes the word “about” and the alternate “scouts” and the division 254d includes the word “11:30” and the alternate “7:30.”

Referring back to FIG. 1, the speech recognizer module 130 may generate the multiple candidate hypotheses 135 from the word lattice 200. That is, the speech recognizer module 130 generates likelihood scores 155 for each of the candidate hypotheses 135 of the word lattice 200. Each likelihood score 155 indicates a probability that the candidate hypotheses 135 is correct (e.g., matches the utterance 101). In some implementations, the speech recognizer module 130 includes an end-to-end (E2E) speech recognition model configured to receive audio data 112 and generate the word lattice 200. In particular, the E2E speech recognition model processes the audio data 112 to generate corresponding likelihood scores 155 for each of the multiple candidate hypotheses 135 from the word lattice 200. In some examples, the speech recognizer module 130 includes a separate acoustic model, language model, and/or pronunciation model.

Notably, the speech recognizer module 130 corresponds to a general-purpose speech recognizer that is trained on general purpose data rendering the speech recognizer module 130 less accurate for recognizing speech in specialized domains that use specialized phrases (e.g., voice commands, medical jargon, legal jargon) and/or named entities (e.g., names of personal contacts, song/artist names, application names). The degradation in accuracy for recognizing speech in these specialized domains is due to sparsity in the general purpose data used to train the speech recognizer module, cross-lingual or rare words, emergence of new entities, and out of vocabulary terms that were not present in the general purpose data.

In some examples, the speech recognizer module 130 includes the acoustic model and/or the language model to generate the word lattice 200 or otherwise generate the multiple candidate hypotheses 135 for the utterance 101 based on the audio data 112. Here, the likelihood scores 155 of the multiple candidate hypotheses 135 may include a combination of an acoustic modeling score from the acoustic model and/or a prior likelihood score from the language model Put another way, the likelihood scores 155 includes at least one of the acoustic modeling score output by the acoustic model and/or the prior likelihood score output by the language model.

During stage (C), in some examples, the computing system 120 identifies a set of highest-ranking candidate hypotheses 135 from multiple candidate hypotheses 135 in the word lattice 200. For example, using likelihood scores 155 from the speech recognizer module 130, the computing system 120 selects n candidate hypotheses 135 with the highest likelihood scores 155, where n is an integer. In some instances, the computing system 120 selects candidate hypotheses 135 with likelihood scores 155 that satisfy a likelihood score threshold. Optionally, the speech recognizer module 130 may rank the set of highest-ranking candidate hypotheses 135 using the likelihood scores 155.

In the example shown, the speech recognizer module 130 generates candidate hypotheses 135 for the utterance 101 “call Petar on mobile” spoken by the user 10. In this example, the top two candidate transcriptions (e.g., the two that are most likely to be correct) are selected as the set of highest ranking candidate hypotheses 135. The highest ranking candidate hypotheses 135 include a first candidate hypothesis 135 “call Peter on mobile” with a likelihood score 155 of 0.8 and a second candidate hypotheses 135 “call Peter Mo and Bill” with a likelihood score 155 of 0.2. Here, a higher likelihood score 155 indicates a greater confidence that the candidate hypothesis 135 is correct. Notably, neither of the highest ranking candidate hypotheses 135 include the utterance 101 actually spoken by the user 10 (e.g., “call Petar on mobile”). Accordingly, if the computing system 120 selects either of the highest ranking candidate hypotheses 135, the transcription 175 output to the user 10 will be incorrect. Moreover, an action carried such as initiating a phone call with a phone number associated with a mobile phone for a contact named Peter would not be the intended action the user 10 was requesting when speaking the utterance 101, thereby requiring the user 10 to cancel the phone call, or if the call is answered by Peter, requiring the user 10 to explain that the call to Peter was accidental.

During stage (D), the computing system 120 executes a correction module 140 that generates one or more new candidate hypotheses 145 for the utterance 101 that were either not included in the existing candidate hypotheses 135 or ranked very low among candidate hypotheses in the lattice 200 output by the speech recognizer module 130 during a first pass. For simplicity, the correction module 140 generates a single new candidate hypothesis 145 “call Petar on mobile” for insertion into the lattice 200. In some implementations, the correction module generates multiple new candidate hypotheses 145. Here, the correction module 140 may correspond to a second pass language model that uses context information 126 to rescore existing hypotheses in the lattice 200 based on a current context and/or generate a new candidate hypotheses 145 relevant to the current context that was entirely missing from the lattice 200. In some examples, the language model of the correction module 140 includes a personalized language model trained to recognize terms personal to the user 10 based on the context information 126. In these examples, the personalized language model may include an auxiliary language model external to the speech recognizer module 130. The correction module 140 may only receive the lattice 200 as input without audio data 110 and generate the new candidate hypothesis 145 that is acoustically similar to the existing candidate hypotheses 135. Additionally or alternatively, the correction module 140 may include a biasing model that boosts scores 155 of hypotheses in the lattice that include terms relevant to the context information 126.

In other examples, the correction module 140 includes a second pass speech recognizer module that processes the audio data 120 with or without the results 135, 200 from the first pass to generate the new candidate hypothesis 145. In these examples, the speech recognizer module 130 may be a streaming speech recognition module that generates streaming transcriptions and the second pass speech recognizer module includes a more computationally intensive speech recognizer that may leverage context information 126 to conceivably produce more accurate descriptions, albeit at increased latency.

The context information 126 may include personalized data and/or in-domain data relevant to a current context when the user 10 spoke the utterance 101 such as, without limitation, a list of the user's contacts, names of items in the user's media library, names of nearby locations, an application currently executing, and names of installed applications. The context information 126 may be stored on the memory hardware 114 of the user device 110 and/or on the memory hardware 124 of the computing system 120. The information in these different contextual data sets will change from time to time, such as when the user adds or deletes contacts, when the user's media library changes, when the user changes location, and so on. The correction module 140 can periodically request updates to the lists of data in order to refresh the contextual information it uses. This may include obtaining information over a network, for example, from a server for a map service, a server hosting information about a user's media library, and so on.

With continued reference to FIG. 1, the comparison model 300 receives the existing word lattice 200 output from the speech recognizer module 130 and the one or more new candidate hypotheses 145 output by the correction module 140. In some examples, the comparison model 300 only receives the existing candidate hypotheses 135 and their corresponding likelihood scores 155 from the existing word lattice 200. The comparison model 300 is trained to have partial awareness that the new candidate hypothesis 145 corresponds to an in-domain (e.g., context-specific) hypothesis while the existing candidate hypotheses 135 for the utterance 101 that were generated by the speech recognizer module 130 trained on general purpose training data correspond to out-of-domain hypotheses.

Notably, using the speech recognizer module 130 to score the new candidate hypothesis 145 (or rescore the new candidate hypothesis that was ranked low in the lattice 200) is not desirable since the speech recognizer module 130 already failed to recall/recognize (or assigned a low likelihood score 155) the new candidate hypotheses 145. On the other hand, the correction module 140 (e.g., a context-specific language model or biasing model) is not trained to rank the in-domain candidate hypothesis 145 relative to the out-of-domain candidate hypotheses 135 generated by the speech recognizer module 130 trained on general purpose training data.

By having partial awareness, the comparison model 300 uses the likelihood score(s) 155 generated by the speech recognizer module 130 for each of one or more of the existing candidate hypotheses 135 in the word lattice 200 as a point of reference for scoring a likelihood score 155 for the new candidate hypothesis 145 inserted into the existing word lattice 200. The comparison model 300 also receives the contextual information 126 as input for scoring the new candidate hypothesis 145 relative to the existing candidate hypotheses 135 to prevent over-triggering the new candidate hypothesis 145 in scenarios it was not spoken, while at the same time, prevents under-recalling the new candidate hypothesis 135 in scenarios it was spoken. Continuing with the example where “call Peter on mobile” is includes existing candidate hypothesis 135 from the lattice 200 and “call Petar on mobile” is the new candidate hypothesis 145, the contextual information 126 allows the comparison model 300 to consider whether Peter and Petar are personal contacts, frequencies of calling Peter and Petar, whether either of Peter or Petar is a common generic entity likely to be spoken, acoustic fit to the audio data 112, and whether other, better (e.g., higher likelihood score 155) are available in the lattice 200.

In addition to the aforementioned types of contextual information 126 listed above with reference to the correction module 140, the contextual information 126 leveraged by the comparison model 300 may indicate whether or not music is playing on the user device 110, content is streaming from the user device 110 onto a screen or media device in communication with the user device 110, an application in the foreground, a dialog state of the foreground application, any on-screen information, an activity performed by the user 10 (e.g., driving, walking, running, cycling, etc.), user history (e.g., prior queries, learned correlations, corrections to previously misrecognized transcriptions, etc.), freshness trends that may be user-specific and/or non-user-specific.

Implementations include the comparison model 300 trained to score a delta between an existing candidate hypothesis 135 and the new candidate hypothesis 145 by assigning a respective likelihood score or probability 355 to both the existing candidate hypothesis (P_{M′}(h)) and the new candidate hypothesis (P_{M′}(h′)) and taking the difference as follows.

$$P ( {h}^{′} ) = {P}_{M} ( h ) ⨯ \frac{{P}_{{M}^{′}} ( {h}^{′} )}{{P}_{{M}^{′}} ( h )} \qquad ( 1 )$$

where M denotes an ASR model of the speech recognizer module, M′ denotes the correction model 300, h denotes the existing candidate hypothesis 135, P_{M}(h) denotes the likelihood score 155 assigned to the existing candidate hypothesis, and h′ denotes the new candidate hypothesis 145. In some examples, the comparison model 300 scores the delta between the existing candidate hypothesis 135 and the new candidate hypothesis 145 in the −log probability cost space as follows.

C(h′)=C_{M}(h)+C_{M′}(h′)−C_{M′}(h) (2)

Continuing with the example above, contextual information 126 indicating that the entity “Peter” in the existing candidate hypothesis 135 is not a contact in the user's list of personal contacts while the entity “Petar” in the new candidate hypothesis 145 is a contact in the list of personal contacts may result in the comparison model (M′) 300 assigning a higher probability score 355 to the new candidate hypothesis 145 than to the existing candidate hypothesis 135 (P_{M′}(h′)>P_{M′}(h)). Accordingly, the positive delta between the existing candidate hypothesis 135 and the new candidate hypothesis 145 is boosted. Conversely, when both “Peter” and “Petar” are contacts in the user's list of personal contacts, the contextual information 126 may further incorporate audio features measuring how closely each hypothesis 135, 145 matches the audio in order to wrongly correct the existing candidate hypothesis 135 that includes a contact name. As such, the use of audio features may allow the comparison model 300 to assign a higher probability score 355 to the existing candidate hypothesis 135 than to the new candidate hypothesis 145.

In another example where the user 10 spoke an utterance 101 of “call Best Buy”, the speech recognizer module 130 may generate the candidate hypothesis 135 “call Best Buy” while the correction module 140 may output the new candidate hypothesis 145 “call Beth Byer” based on context information 126 indicating the entity “Beth Byer” in the list of personal contacts of the user 10. Notably, the existing and new candidate hypotheses are phonetically close to one another. Rather than simply over triggering the selection of the new candidate hypothesis 145 “call Beth Byer” as the resulting transcription 175, the comparison model 300 may analyze other relevant context information 126 when scoring the new candidate hypothesis 145 relative to the existing candidate hypothesis 135. For instance, while the context information 126 may indicate that “Beth Byer” is indeed one of the user's personal contacts, the context information 126 further reveals that “Beth Byer” is a lower-tier personal contact who is rarely, or even never, called by the user, rendering the personalized candidate hypothesis 145 relatively weak compared to the strong non-personal candidate hypothesis 135 “call Best Buy”. Accordingly, the comparison model 300 assign a lower probability score 355 to the new candidate hypothesis 145 than to the original existing candidate hypothesis 135.

In yet another example, the user 10 spoke an utterance 101 “play Reforget by Lauv” that the speech recognizer module 130 misrecognizes as the candidate hypothesis 135 “play we forget by love”. Thereafter, the correction module 140 inserts the correct recognition result “play Reforget by Lauv” as an additional new candidate hypothesis 145 into the lattice 200. In this example, while both the existing and new candidate hypotheses 135, 145 are non-personal queries, the comparison model 300 having awareness of song and artist names (during training and/or from the contextual information 126) may assign a higher probability score 355 to the correct new candidate hypothesis 145 than to the existing candidate hypothesis 135.

As revealed by the above examples, the comparison model 300 need not be accurate in an absolute sense when scoring a new candidate hypothesis 145 relative to an existing candidate as long as the estimation/prediction of both likelihood scores are overestimated by an equal amount With this objective, training of the comparison model 300 is simplified and the size of the comparison model 300 can be reduced. Under the simplest scenarios, the comparison model 300 is tasked with modeling a prior likelihood score of a hypothesis devoid of any consideration of additional contextual information 126. For instance, consider an example where an utterance of computer jargon is misrecognized by the speech recognition module 130 as the candidate hypothesis 135 “mexican currency” and the correction module 140 inserts the recognition result “max concurrency” as a new candidate hypothesis 145 into the lattice 200. In this example, the comparison model 300 is trained on the computer jargon domain and may appropriately assign a higher probability score 355 to the new candidate hypothesis 145 than to the existing candidate hypothesis 135.

The comparison model 300 may evaluate and score the new candidate hypothesis 145 against a single existing candidate hypothesis 135 and its corresponding likelihood score 155. The single existing candidate hypothesis 135 may be cherry-picked for better scoring accuracy based on, for example, a high acoustic proximity to the new candidate hypothesis 145 and/or familiarity with similar hypothesis for use as reference points. Alternatively, the comparison module 300 may evaluate and score the new candidate hypothesis 145 against multiple existing candidate hypotheses 135 (or even all hypothesis in the original lattice 200) and their corresponding likelihood scores 155 to provide more accurate scoring at the cost increased computation burden (adding to increased latency and increased memory requirements).

With continued reference to FIG. 1, during stage (F), a re-ranker 160 receives the likelihood score 155 for the new candidate hypothesis 145 from the comparison model 300 and the likelihood score(s) 155 for each of the one or more existing candidate hypotheses 135 from the speech recognizer module 130. The re-ranker 160 is configured to output a re-ranked result 164 that includes the rankings the existing candidate hypotheses 135 and the new candidate hypothesis 145 based on the likelihood scores. In the example shown, the re-ranked result 165 includes the new candidate hypothesis 145 with a likelihood score 155 of 0.9 as the most likely correct transcription 175.

At stage (G), the computing system 120 is configured to generate a transcription 175 of the utterance 101 spoken by the user 10 by selecting the highest ranking candidate in the re-ranked result 165. In the example shown, the computing system 120 selects the new candidate hypothesis 145 “call Petar on mobile” because it has the highest likelihood score 155 of 0.9. The computing system 120 may transmit the transcription 175, via the network 118, to the client device 110 to provide the transcription 175 to the user 10. In some implementations, the client device 110 performs all of stages (A)-(G) on device without the need to connect to the computing system 120 via the network 118.

While the above examples depict scoring new candidate hypotheses relative to existing candidate hypotheses for audio-based speech inputs, aspects of the present disclosure are equally applicable for scoring new candidate hypotheses relative to existing candidate hypotheses for non-speech inputs. For instance, a non-speech input 113 may include a user input indication indicating selection of one or more characters of the keyboard 117 (e.g., virtual or physical keyboard) in communication with the data processing hardware 114 of the client device 110. In this example, the speech recognizer module 130 may be replaced by a keyboard detection module configured to generate a lattice 200 of candidate hypotheses 135 for the non-speech input 113. The correction module 140 may function similarly to the examples above by generating a new candidate hypotheses for the non-speech input 113 that may be inserted into the lattice 200. The comparison model 300 may then score the new candidate hypothesis relative to the existing candidate hypotheses, thereby providing the ability to rank a non-speech recognition hypothesis that is in-domain relative to out-of-domain traffic that includes terms which the keyboard detection module may not have been trained on.

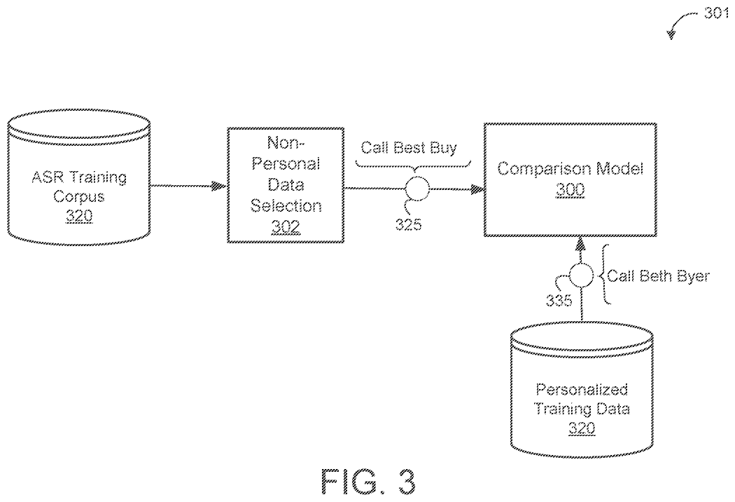

Referring now to FIG. 3, in some implementations, an example training process 301 trains the comparison model 300 to learn how to score in-domain candidate hypotheses relative to out-of-domain candidate hypotheses. The training process 301 may train the model 300 on a non-personal training data subset 325 that includes general data used for training the speech recognition module 130 and a personal training data subset 335. An ASR training corpus 320 may include a corpus of ground-truth transcriptions used to train the speech recognizer module 130. In some examples, a non-personal data selector 302 selects the non-personal training data subset 325 for training the comparison model 300 from the ASR training corpus 320. Here, the non-personal data selector 302 may select transcriptions from the corpus 320 that commonly occur in real-life traffic, and thus, may include transcriptions that are not personal in nature. For instance, a transcription in the non-personal training data subset 325 may include “call Best Buy”. On the other hand, the non-personal training data subset 325 may include transcriptions that are personal in nature. For instance, a transcription in the personal training data subset 335 may include “call Beth Byer” Some transcriptions from the non-personal training data subset 325 may be obtained from the ASR training corpus 320. The personal training data subset 335 may be anonymized prior to training the comparison model 300. Further, personal terms/entities in the personal training data subset 335 may be factored out into a nonterminal such as “call $CONTACT”. As such, exposure to both slices of traffic (e.g., non-personalized and personalized training data subsets) allows the comparison model 300 to learn how to model probability scores 355 for the hypotheses in proportion to their relative occurrence in traffic.

Notably, a third-party developer that may use the training process 301 for training a customized comparison model 300 to extend an existing speech recognizer module 130 with custom hypotheses, such as hypotheses from brand-new semantic classes/domains that were absent from training data set (e.g., ASR training corpus 320) used to train the speech recognizer module 130. Under this scenario, the developer may provide a mechanism for inserting the new additional hypotheses into an existing ASR lattice 200 or n-best list generated by the speech recognizer module 130. For instance, mechanism may include a grammar list provided to a correction module 130 (e.g., ASR correction/named entity injection system) for inserting new candidate hypotheses into the lattice. As such, the developer may use the training process 301 to train the comparison model 130 on both a mix of original (e.g., non-personalized training data subset 325) and new (e.g., personalized training data subset 335) training data.

During inference, after ASR decoding and inserting the new entities/hypotheses 145, the client-provided comparison model 300 could be used as a delta to score the new candidate hypothesis 145 relative to one or more existing candidate hypotheses 135. Note that a client/developer can get away with using just the head of the distribution of the “original” traffic since the frequent queries are typically highly aggregated data that is less problematic for a third party to obtain and use from a privacy point of view.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

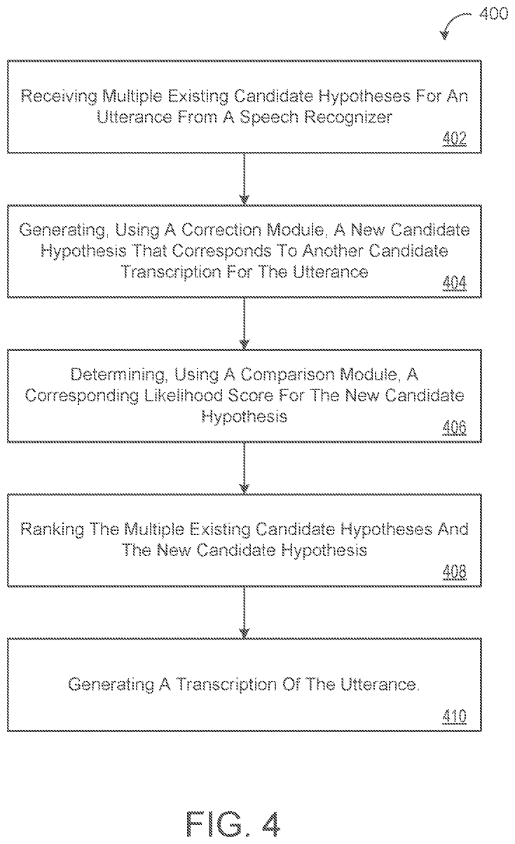

FIG. 4 is a flowchart of an example arrangement of operations for a method 400 of scoring a new candidate hypothesis 145 inserted into an existing lattice 200 of candidate hypotheses 135 for an utterance 101 spoken by a user 10. The data processing hardware 122 (FIG. 1) may execute instructions stored on the memory hardware 124 (FIG. 1) to perform the example arrangement of operations for the method 400. At operation 402, the method 400 includes receiving, from a speech recognizer 130, multiple existing candidate hypotheses 135 for the utterance 101 spoken by the user 10. Here, existing candidate hypothesis 135 of the multiple existing candidate hypotheses corresponds to a candidate transcription for the utterance 101 and has a corresponding likelihood score 155 assigned by the speech recognizer 130 to the corresponding existing candidate hypothesis 135.

At operation 404, the method 400 includes generating, using a correction module 140 configured to receive the multiple candidate hypotheses 135 as input, a new candidate hypothesis 145 that corresponds to another candidate transcription for the utterance 101. At operation 406, after generating the new candidate hypothesis 145, the method 400 also includes determining, using a comparison model 300 configured to receive the corresponding likelihood score 155 assigned to one of the multiple existing candidate hypotheses 135 as input, a corresponding likelihood score 155 for the new candidate hypothesis 145.

At operation 408, the method 400 also includes ranking the multiple existing candidate hypotheses 135 and the new candidate hypothesis 145 based on the corresponding likelihood scores 155 assigned to the multiple existing candidate hypothesis 135 by the speech recognizer 130 and the corresponding likelihood score 155 determined for the new candidate hypothesis 145 using the comparison model 300. At operation 410, the method 400 includes generating a transcription 175 of the utterance 101 by selecting the highest ranking one of the new candidate hypothesis 145 and the multiple existing candidate hypotheses 135.

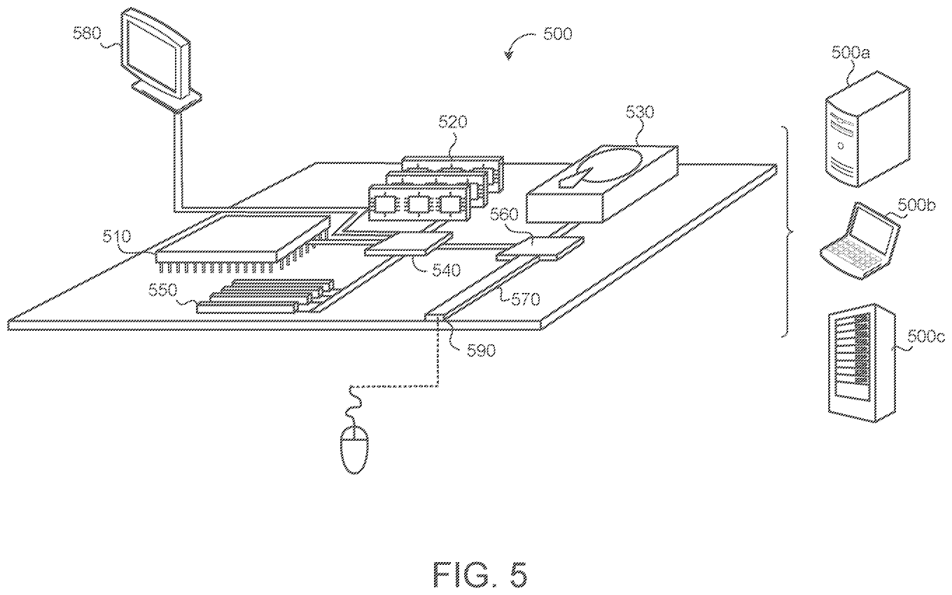

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks, magneto optical disks, and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
receiving, from a speech recognizer, multiple existing candidate hypotheses for an utterance spoken by a user, each existing candidate hypothesis of the multiple existing candidate hypotheses corresponding to a candidate transcription for the utterance and having a corresponding likelihood score assigned by the speech recognizer to the corresponding existing candidate hypothesis;
generating, using a correction module configured to receive the multiple candidate hypotheses as input, a new candidate hypothesis that corresponds to another candidate transcription for the utterance;
after generating the new candidate hypothesis, determining, using a comparison model configured to receive the corresponding likelihood score assigned to one of the multiple existing candidate hypotheses as input, a corresponding likelihood score for the new candidate hypothesis;
ranking the multiple existing candidate hypotheses and the new candidate hypothesis based on the corresponding likelihood scores assigned to the multiple existing candidate hypothesis by the speech recognizer and the corresponding likelihood score determined for the new candidate hypothesis using the comparison model; and
generating a transcription of the utterance spoken by the user by selecting the highest ranking one of the new candidate hypothesis and the multiple existing candidate hypotheses.

2. The computer-implemented method of claim 1, wherein the operations further comprise:
receiving audio data corresponding to an utterance spoken by a user; and
processing, using the speech recognizer, the audio data to generate a lattice of candidate hypotheses having corresponding likelihood scores assigned by the speech recognizer,
wherein receiving the multiple existing candidate hypotheses comprises selecting an n-best list of the candidate hypotheses that have the highest corresponding likelihood scores assigned by the speech recognizer.

3. The computer-implemented method of claim 2, wherein the new candidate hypothesis generated using the correction module comprises one of the candidate hypotheses in the lattice of candidate hypotheses that having a corresponding likelihood score that is less than each of the corresponding likelihood scores assigned to the n-best list of candidate hypotheses from the lattice.

4. The computer-implemented method of claim 2, wherein the new candidate hypothesis generated using the correction module is absent from the lattice of candidate hypotheses.

5. The computer-implemented method of claim 1, wherein the correction module comprises an auxiliary language model external to the speech recognizer.

6. The computer-implemented method of claim 1, wherein the operations further comprise:
receiving context information indicating a current context when the user spoke the utterance,
wherein, when generating the new candidate hypothesis, the correction module is further configured to receive the context information as input.

7. The computer-implemented method of claim 1, wherein the operations further comprise:
receiving context information indicating a current context when the user spoke the utterance,
wherein, when determining corresponding likelihood score for the new candidate hypothesis, the comparison model is further configured to receive the context information as input.

8. The computer-implemented method of claim 7, wherein the context information comprises at least one of:
a list of personal contacts of the user;
names of items in in a media library associated with the user;
names of nearby locations,
an application currently executing on a user device associated with the user; or
names of applications installed on the user device.

9. The computer-implemented method of claim 7, wherein the context information indicates at least one of:
music is playing on a user device associated with the user;
content is streaming from the user device onto a screen or media device in communication with the user device;
an application executing on the user device in the foreground;
a dialog state of the foreground application;
any on-screen information;
a current activity being performed by the user;
user history data; or
any user-specific and/or non-user-specific freshness trends.

10. The computer-implemented method of claim 1, wherein the speech recognizer comprises an end-to-end speech recognition model configured to generate the corresponding likelihood score for each of the multiple existing candidate hypotheses.

11. A system comprising:
data processing hardware; and
memory hardware in communication with the data processing hardware and storing instructions that when executed on the data processing hardware cause the data processing hardware to perform operations comprising:
receiving, from a speech recognizer, multiple existing candidate hypotheses for an utterance spoken by a user, each existing candidate hypothesis of the multiple existing candidate hypotheses corresponding to a candidate transcription for the utterance and having a corresponding likelihood score assigned by the speech recognizer to the corresponding existing candidate hypothesis;
generating, using a correction module configured to receive the multiple candidate hypotheses as input, a new candidate hypothesis that corresponds to another candidate transcription for the utterance;
after generating the new candidate hypothesis, determining, using a comparison model configured to receive the corresponding likelihood score assigned to one of the multiple existing candidate hypotheses as input, a corresponding likelihood score for the new candidate hypothesis;
ranking the multiple existing candidate hypotheses and the new candidate hypothesis based on the corresponding likelihood scores assigned to the multiple existing candidate hypothesis by the speech recognizer and the corresponding likelihood score determined for the new candidate hypothesis using the comparison model; and
generating a transcription of the utterance spoken by the user by selecting the highest ranking one of the new candidate hypothesis and the multiple existing candidate hypotheses.

12. The system of claim 11, wherein the operations further comprise:
receiving audio data corresponding to an utterance spoken by a user; and
processing, using the speech recognizer, the audio data to generate a lattice of candidate hypotheses having corresponding likelihood scores assigned by the speech recognizer,
wherein receiving the multiple existing candidate hypotheses comprises selecting an n-best list of the candidate hypotheses that have the highest corresponding likelihood scores assigned by the speech recognizer.

13. The system of claim 12, wherein the new candidate hypothesis generated using the correction module comprises one of the candidate hypotheses in the lattice of candidate hypotheses that having a corresponding likelihood score that is less than each of the corresponding likelihood scores assigned to the n-best list of candidate hypotheses from the lattice.

14. The system of claim 12, wherein the new candidate hypothesis generated using the correction module is absent from the lattice of candidate hypotheses.

15. The system of claim 11, wherein the correction module comprises an auxiliary language model external to the speech recognizer.

16. The system of claim 11, wherein the operations further comprise:
receiving context information indicating a current context when the user spoke the utterance,
wherein, when generating the new candidate hypothesis, the correction module is further configured to receive the context information as input.

17. The system of claim 11, wherein the operations further comprise:
receiving context information indicating a current context when the user spoke the utterance,
wherein, when determining corresponding likelihood score for the new candidate hypothesis, the comparison model is further configured to receive the context information as input.

18. The system of claim 17, wherein the context information comprises at least one of:
a list of personal contacts of the user;
names of items in in a media library associated with the user;
names of nearby locations,
an application currently executing on a user device associated with the user; or
names of applications installed on the user device.

19. The system of claim 17, wherein the context information indicates at least one of:
music is playing on a user device associated with the user;
content is streaming from the user device onto a screen or media device in communication with the user device;
an application executing on the user device in the foreground;
a dialog state of the foreground application;
any on-screen information;
a current activity being performed by the user;
user history data; or
any user-specific and/or non-user-specific freshness trends.

20. The system of claim 11, wherein the speech recognizer comprises an end-to-end speech recognition model configured to generate the corresponding likelihood score for each of the multiple existing candidate hypotheses.
